(19) United States
(12) Patent Application Publication
(10) Pub. No.: US 2026/0095376 A1
(43) Pub. Date: Apr. 2, 2026

(54) SYSTEM AND METHOD FOR PROCESSING NETWORK REQUESTS WITH ULTRA SCALE THROUGHPUT AND LOW LATENCY IN A NETWORKED COMPUTING ENVIRONMENT

(71) Applicant: BANK OF AMERICA CORPORATION, CHARLOTTE, NC (US)

(72) Inventors: Pradeep Jahagirdar, Princeton, NJ (US); Damon A. Davis, Charlotte, NC (US); Christopher T. Edwards, Weston, CT (US)

(73) Assignee: BANK OF AMERICA CORPORATION, CHARLOTTE, NC (US)

(21) Appl. No.: 18/904,533

(22) Filed: Oct. 2, 2024

(51) Int. Cl. H04L 41/0823; H04L 43/0852

(52) U.S. Cl. CPC H04L 41/0823; H04L 43/0852

(57) ABSTRACT

A system is provided for processing network requests with ultra scale throughput and low latency in a networked computing environment. In particular, the system may comprise a distributed server network that may use one or more data apply engines to record changes occurring within a data mainframe. The changes may be recorded in the distributed server network through a number of discrete event-apply processes. A consensus mechanism may be selected by the system to ensure the resiliency and uniqueness of the recorded events while maintaining high throughput to ensure that the changes are recorded expediently (e.g., in real-time or near real-time). In this way, the system may ensure that the data regarding the events are highly available and may be served with low latency and high accuracy.

### TECHNOLOGICAL FIELD

Example embodiments of the present disclosure relate to a system for processing network requests with ultra scale throughput and low latency in a networked computing environment.

### BACKGROUND

There is a need for a way to process network requests in an expedient, resilient, and non-duplicative manner.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for processing network requests with ultra scale throughput and low latency in a networked computing environment. In particular, the system may comprise a distributed server network that may use one or more data apply engines to record changes occurring within a data mainframe. The changes may be recorded in the distributed server network through a number of discrete event-apply processes. A consensus mechanism may be selected by the system to ensure the resiliency and uniqueness of the recorded events while maintaining high throughput to ensure that the changes are recorded expediently (e.g., in real-time or near real-time). In this way, the system may ensure that the data regarding the events are highly available and may be served with low latency and high accuracy.

Accordingly, embodiments of the present disclosure provide a system for processing network requests with ultra scale throughput and low latency in a networked computing environment, the system comprising: a processing device; a non-transitory storage device containing instructions when executed by the processing device, cause the processing device to perform the steps of: detecting, in real time, one or more changes within a central data repository; storing one or more event records within a distributed data register, wherein the one or more event records comprise the one or more changes within the central data repository; receiving a network request from an external computing device; modifying one or more optimization parameters associated with the network request based on one or more performance metrics, wherein the one or more performance metrics comprise a data availability metric, a latency metric, and a data throughput metric; and serving the network request based on accessing the one or more event records within the distributed data register.

In some embodiments, each of the one or more event records comprises a key parameter, a value, a timestamp, and metadata.

In some embodiments, the one or more event records are stored across one or more partitions of an event group within the distributed data register.

In some embodiments, a first event record and a second event record of the one or more event records are stored in a first partition of the one or more partitions based on the first event record and the shared event record sharing a common characteristic, wherein the common characteristic is a key parameter.

In some embodiments, modifying the one or more optimization parameters comprises increasing a number of the one or more partitions within the distributed register.

In some embodiments, the latency metric comprises a latency target of less than 150 ms of end-to-end latency.

In some embodiments, the data throughput metric comprises a data throughput target of at least 100,000 transactions per second.

Embodiments of the present disclosure also provide a computer program product for processing network requests with ultra scale throughput and low latency in a networked computing environment, the computer program product comprising a non-transitory computer-readable medium comprising code causing an apparatus to perform the steps of: detecting, in real time, one or more changes within a central data repository; storing one or more event records within a distributed data register, wherein the one or more event records comprise the one or more changes within the central data repository; receiving a network request from an external computing device; modifying one or more optimization parameters associated with the network request based on one or more performance metrics, wherein the one or more performance metrics comprise a data availability metric, a latency metric, and a data throughput metric; and serving the network request based on accessing the one or more event records within the distributed data register.

In some embodiments, each of the one or more event records comprises a key parameter, a value, a timestamp, and metadata.

In some embodiments, the one or more event records are stored across one or more partitions of an event group within the distributed data register.

In some embodiments, a first event record and a second event record of the one or more event records are stored in a first partition of the one or more partitions based on the first event record and the shared event record sharing a common characteristic, wherein the common characteristic is a key parameter.

In some embodiments, modifying the one or more optimization parameters comprises increasing a number of the one or more partitions within the distributed register.

In some embodiments, the latency metric comprises a latency target of less than 150 ms of end-to-end latency.

Embodiments of the present disclosure also provide a computer-implemented method for processing network requests with ultra scale throughput and low latency in a networked computing environment, the computer-implemented method comprising: detecting, in real time, one or more changes within a central data repository; storing one or more event records within a distributed data register, wherein the one or more event records comprise the one or more changes within the central data repository; receiving a network request from an external computing device; modifying one or more optimization parameters associated with the network request based on one or more performance metrics, wherein the one or more performance metrics comprise a data availability metric, a latency metric, and a data throughput metric; and serving the network request based on accessing the one or more event records within the distributed data register.

In some embodiments, each of the one or more event records comprises a key parameter, a value, a timestamp, and metadata.

In some embodiments, the one or more event records are stored across one or more partitions of an event group within the distributed data register.

In some embodiments, a first event record and a second event record of the one or more event records are stored in a first partition of the one or more partitions based on the first event record and the shared event record sharing a common characteristic, wherein the common characteristic is a key parameter.

In some embodiments, modifying the one or more optimization parameters comprises increasing a number of the one or more partitions within the distributed register.

In some embodiments, the latency metric comprises a latency target of less than 150 ms of end-to-end latency.

In some embodiments, the data throughput metric comprises a data throughput target of at least 100,000 transactions per second.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing system for processing network requests with ultra scale throughput and low latency in a networked computing environment, in accordance with an embodiment of the disclosure;

FIG. 2A illustrates an exemplary DLT architecture, in accordance with an embodiment of the disclosure;

FIG. 2B illustrates an exemplary transaction object within the DLT architecture, in accordance with an embodiment of the disclosure; and

FIG. 3 illustrates a method for processing network requests with ultra scale throughput and low latency in a networked computing environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, unique characteristic information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may refer to a tangible or intangible object that may be used, consumed, maintained, acquired, exchanged, and/or the like by a system, entity, or user to accomplish certain objectives. Accordingly, in some embodiments, the resources may include computing resources such as processing power, memory space, network bandwidth, bus speeds, storage space, electricity, and/or the like. In other embodiments, the resources may include objects such as electronic data files or values, authentication keys (e.g., cryptographic keys), document files, funds, digital currencies, and/or the like.

A mainframe or centralized data repository within an enterprise network environment may receive a high volume (e.g., millions) of network requests per unit time (e.g., read and/or write requests such as data requests, processing requests, and/or the like). Serving such a large number of network requests may pose a number of technological challenges. For instance, the mainframe should be able to support a high throughput with low end-to-end latency to ensure that the network requests are processed in a timely manner while ensuring high availability and accuracy. Accordingly, there is a need for a way to balance the performance considerations and parameters for processing incoming network requests.

To address the above concerns among others, the system may provide a scalable, fault-tolerant, and high-performance platform for receiving and processing network requests in an expedient, accurate, and non-duplicative or unique manner. In particular, the system may comprise a distributed server network that may comprise one or more producer servers that continuously monitor the mainframe for changes that are recorded within the mainframe. The producer servers may detect the changes and store the changes (e.g., within one or more storage servers within the distributed server network) in real time or near real-time in the form of event records. In this regard, the servers may use one or more connection plugins to connect to the legacy systems within the network environment. Each event record may comprise one or more parameters, one or more values, a timestamp, metadata (e.g., headers, descriptions, and/or the like), and/or the like. In an exemplary embodiment, an entity such as a financial institution may store information regarding incoming or outgoing transactions from resource accounts. In such a scenario, an event record may include a key parameter (e.g., an identifier of a resource account or a user associated with the resource account, a value (e.g., an amount of resources transferred in to or out from the account), a timestamp (e.g., a date and time), and metadata (e.g., a description such as “withdrawal”).

The one or more storage servers may store all of the event records in a distributed manner as part of a distributed data register. The system may group the event records according to a common topic. Continuing the above example, events that relate to a payment may be grouped within a topic called “payments,” whereas events that relate to account balance changes may be grouped within a topic called “balance.” In such a scenario, the producer servers may write the event records to the appropriate topic within the distributed data register. Each topic may be separated into one or more partitions, where each partition may be stored on a storage server within the distributed server network. The partitions may be created based on events that share a characteristic, such as a key parameter, time range, and/or the like. In some embodiments, a topic or partition may be replicated across multiple storage servers to provide additional fault tolerance. For instance, the topics or partitions may be stored across multiple data centers in various geographic regions. In this regard, the event records stored in the distributed data register may be hosted on the storage servers (or “nodes”) using a consensus mechanism. For example, the consensus mechanism may require that a quorum or majority of the partition leaders agree on the order and contents of the event record to be stored within each of the nodes. In this way, the system may ensure the accuracy and validity of the event records stored in the distributed data register.

Subsequently, the system may receive one or more network requests from client computing devices. For instance, the network requests may include transaction requests or balance inquiries. Based on receiving the network requests, the system may use one or more consumer servers (servers within the distributed server network) to access the partitions associated with the network request (e.g., the partition containing the event records related to the request) and process the network request by serving the relevant data (e.g., account balance information) and/or by executing the relevant processes (e.g., initiating a transaction). In some embodiments, the consumer servers may use one or more connectors to connect with an external system (e.g., a destination system). Each of the consumer servers may be assigned to a consumer group, where each partition within a topic is assigned to a single consumer server within a group (e.g., in a round-robin manner). In this way, the system may ensure that the partitions may be processed in parallel and balanced manner while further preventing the duplication of processing or data.

The system may be configured to balance high throughput (e.g., about 100,000 transactions per second), low end-to-end latency (e.g., less than 150 milliseconds), and high volume (e.g., about 100 million transactions per day) while maintaining high availability and preserving uniqueness of events recorded within the distributed data register. For example, to reduce end-to-end latency and/or improve throughput, the system may implement parallel processing, I/O optimizations, load balancing, batch processing, decoupling of components to enable asynchronous messaging, database sharding, pipeline processing, vertical and horizontal scaling, data compression, performance monitoring, and/or the like.

In some embodiments, the system may perform tuning to modify one or more optimization parameters to achieve the desired performance. For example, the system may increase or decrease the number of topics and/or partitions into which the events may be stored, which may affect the latency and/or throughput of the network. The system may further modify the number of components in the architecture that are used to host the distributed server network. For instance, the system may recruit additional producer and/or consumer servers to perform the message processing and/or enable multithreading for efficient processing of network requests. Additionally or alternatively, the system may modify the number of connection plug-ins (or “connector”) and/or tasks running in each connector.

The system as described herein provides numerous technical advantages over conventional database systems. For example, by intelligently configuring various optimization parameters, the system may provide high performance processing of network requests while ensuring the availability of the data for processing the network requests. Furthermore, by storing event records in a distributed manner, the system may ensure the validity of the stored data while further providing a high level of fault tolerance.

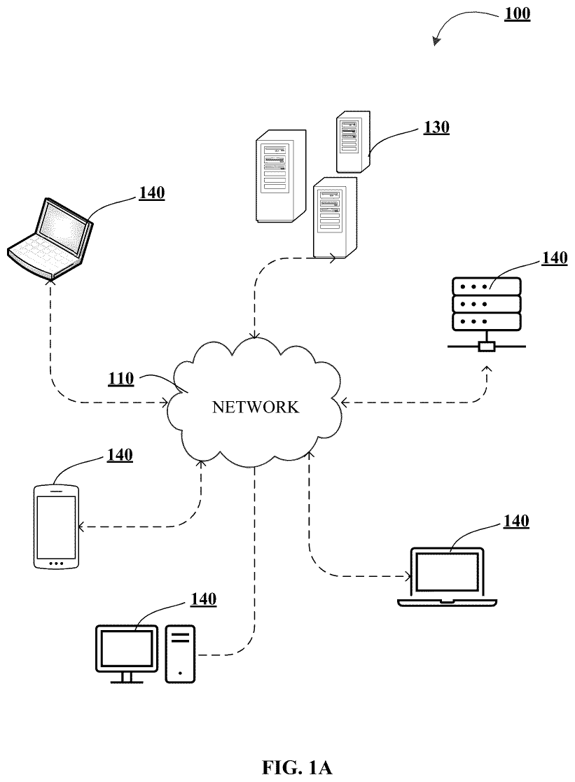

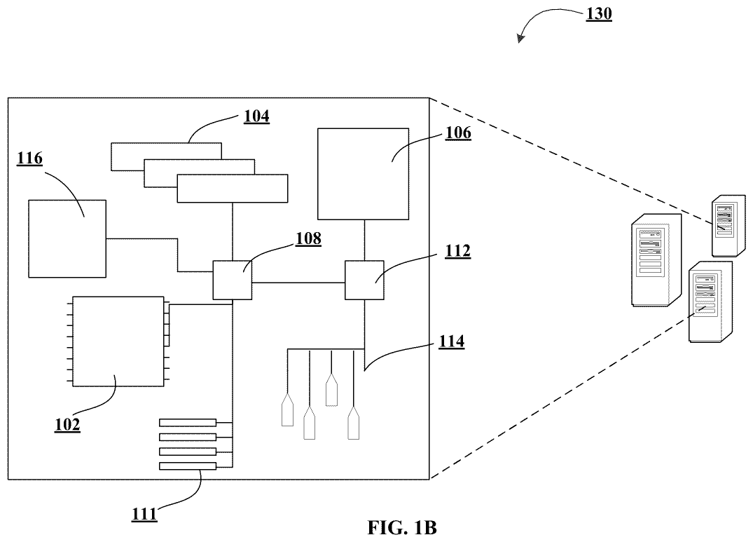

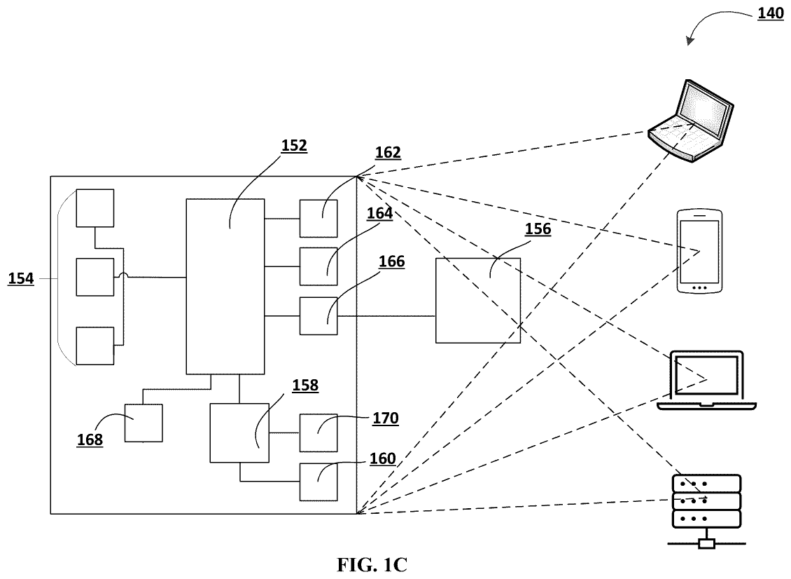

Turning now to the figures, FIGS. 1A-1C illustrate technical components of an exemplary distributed computing environment 100 for the system for processing network requests with ultra scale throughput and low latency in a networked computing environment. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102 (which may also be referred to herein as a “processing device”), memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

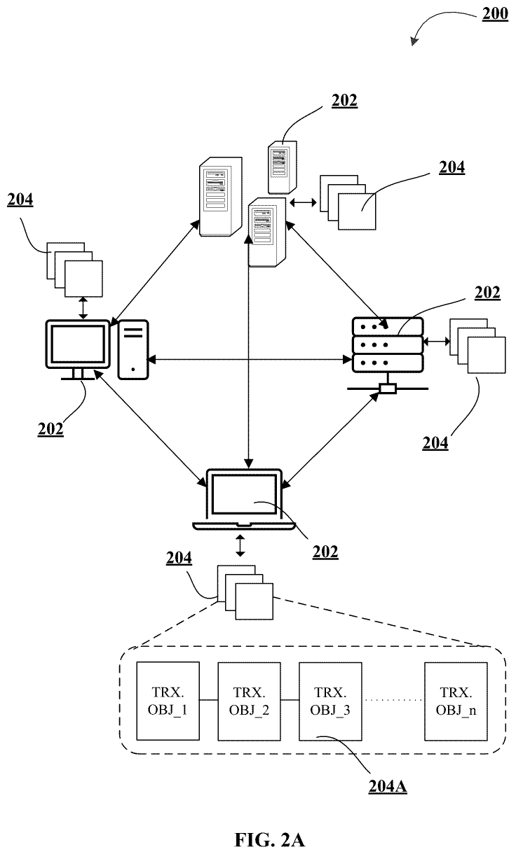

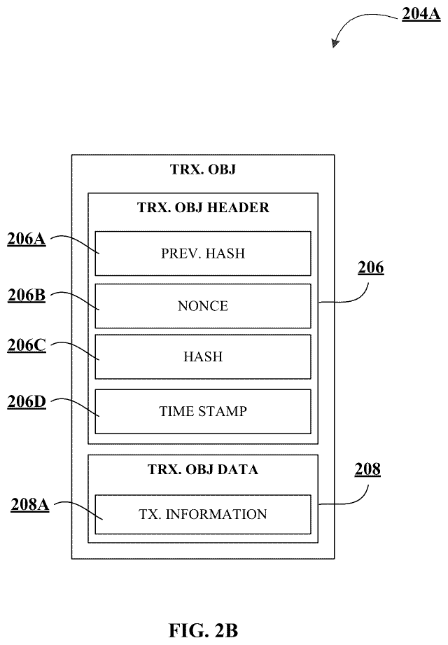

FIGS. 2A-2B illustrate an exemplary distributed ledger technology (DLT) architecture, in accordance with an embodiment of the invention. The distributed ledger may also be referred to herein as a “distributed register.” DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT may use a peer-to-peer protocol for a cryptographically secured distributed ledger of transactions represented as transaction objects (which may also be referred to herein as “data records”) that are linked. In some embodiments, the transaction objects or data records may contain state information about a resource that is tracked by the system. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT may use smart contracts. “Smart contracts” as used herein may refer to computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A “public distributed ledger” as referred to herein may refer to a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, a fully private distributed ledger may be a distributed ledger whereby permissions are kept centralized with one entity. The permissions may be public or restricted to an arbitrary extent. And lastly, a consortium distributed ledger may be a distributed ledger where the consensus process is controlled by a pre-selected set of nodes; for example, a distributed ledger may be associated with a number of member institutions (e.g., 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes. The transaction objects 204A may comprise an origin transaction object that may serve as the beginning of a chain of transaction objects, such that transaction objects 204A are added to the end of the chain beginning from the origin transaction object. In some embodiments, a subchain may be formed from any of the transaction objects 204A within the distributed ledger 204, where the subchain may comprise information relating to a specific resource tracked by the system.

As shown in FIG. 2B, an exemplary transaction object 204A may include a transaction header 206 and a transaction object data 208. The transaction header 206 may include a cryptographic hash of the previous transaction object 206A, a nonce 206B—a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

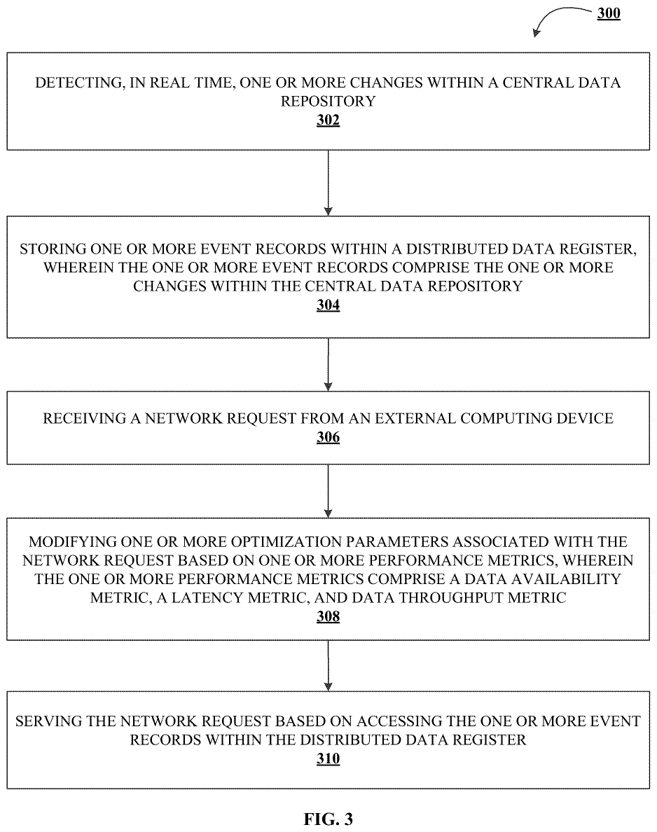

FIG. 3 illustrates a method 300 for processing network requests with ultra scale throughput and low latency in a networked computing environment. As shown in block 302, the method includes detecting, in real time, one or more changes within a central data repository. The changes may include, for instance, additions, deletions, or modifications of the data within the central data repository. In this regard, the producer servers may connect to the central data repository through one or more connection plugins. The producer servers may continuously monitor the changes occurring within the central data repository and subsequently record each change in real time in the form of event records.

Next, as shown in block 304, the method includes storing one or more event records within a distributed data register, wherein the one or more event records comprise the one or more changes within the central data repository. Each of the one or more event records may comprise at least one of a key parameter, a value, a timestamp, and/or metadata, where the information within the event records are created based on the data and changes within the central data repository. In some embodiments, the one or more event records may be stored within the distributed data register across one or more partitions within an event group or topic in the distributed data register, where each event record may be stored in a specific partition. In some embodiments, some event records (e.g., a first event record and a second event record) may be stored in a particular partition (e.g., a first partition) based on the first event record and the second event record sharing a common characteristic such as a key parameter, values within a specified range, timestamps within a specified range, common descriptors in the metadata, and/or the like.

Next, as shown in block 306, the method includes receiving a network request from an external computing device. The network request may be, for example, a data request for data stored within the centralized data repository and/or the distributed data register. In other embodiments, the network request may be a request by the external computing device to execute a specific process. In an exemplary embodiment, a user may connect to the distributed server network using a user computing device (e.g., a mobile smartphone) to submit a request to execute a transaction using a resource account associated with the user. In such an embodiment, the system may use the data stored within the distributed data register to fulfill the network request.

Next, as shown in block 308, the method includes modifying one or more optimization parameters associated with the network request based on one or more performance metrics, wherein the one or more performance metrics comprise a data availability metric, a latency metric, and a data throughput metric. For instance, modifying the one or more optimization parameters may comprise increasing a number of the one or more partitions or topics associated with the one or more event records. In other embodiments, modifying the one or more optimization parameters may comprise assigning additional servers (e.g., consumer servers and/or producer servers) to the one or more partitions or topics. In yet other embodiments, modifying the one or more optimization parameters may comprise enabling hyperthreading to process the one or more partitions in parallel. It should be understood that further changes to optimization parameters may be implemented, such as batch processing, load balancing, database sharding, data compression, and/or the like. In some embodiments, the performance metrics may be balanced based on specified performance targets. For instance, the system may modify the optimization parameters to meet a latency target of less than 150 ms for end-to-end latency. It should be understood that other latency targets may be set by the system, such as less than 200 ms, less than 100 ms, less than 50 ms, and/or the like. The system may further modify the optimization parameters to meet a data throughput target of at least 100,000 transactions per second, at least 50,000 transactions per second, at least 10,000 transactions per second, and/or the like.

Next, as shown in block 310, the method includes serving the network request based on accessing the one or more event records within the distributed data register. In the case that the network request is a request for specified data (e.g., an account balance inquiry), serving the network request may comprise retrieving the relevant data from the event records within the distributed data register and transmitting the specified data to the external computing device. On the other hand, if the network request is a request to execute a process (e.g., a transaction request), serving the network request may comprise accessing the one or more event records within the distributed data register and executing the process based on the information within the one or more event records. In this way, the system may provide a reliable and efficient way to process network requests with a high level of performance.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for processing network requests with ultra scale throughput and low latency in a networked computing environment, the system comprising:
a processing device;
a non-transitory storage device containing instructions when executed by the processing device, cause the processing device to perform the steps of:
detecting, in real time, one or more changes within a central data repository;
storing one or more event records within a distributed data register, wherein the one or more event records comprise the one or more changes within the central data repository;
receiving a network request from an external computing device;
modifying one or more optimization parameters associated with the network request based on one or more performance metrics, wherein the one or more performance metrics comprise a data availability metric, a latency metric, and a data throughput metric; and
serving the network request based on accessing the one or more event records within the distributed data register.

2. The system of claim 1, wherein each of the one or more event records comprises a key parameter, a value, a timestamp, and metadata.

3. The system of claim 1, wherein the one or more event records are stored across one or more partitions of an event group within the distributed data register.

4. The system of claim 3, wherein a first event record and a second event record of the one or more event records are stored in a first partition of the one or more partitions based on the first event record and the second event record sharing a common characteristic, wherein the common characteristic is a key parameter.

5. The system of claim 3, wherein modifying the one or more optimization parameters comprises increasing a number of the one or more partitions within the distributed data register.

6. The system of claim 1, wherein the latency metric comprises a latency target of less than 150 ms of end-to-end latency.

7. The system of claim 1, wherein the data throughput metric comprises a data throughput target of at least 100,000 transactions per second.

8. A computer program product for processing network requests with ultra scale throughput and low latency in a networked computing environment, the computer program product comprising a non-transitory computer-readable medium comprising code causing an apparatus to perform the steps of:
detecting, in real time, one or more changes within a central data repository;
storing one or more event records within a distributed data register, wherein the one or more event records comprise the one or more changes within the central data repository;
receiving a network request from an external computing device;
modifying one or more optimization parameters associated with the network request based on one or more performance metrics, wherein the one or more performance metrics comprise a data availability metric, a latency metric, and a data throughput metric; and
serving the network request based on accessing the one or more event records within the distributed data register.

9. The computer program product of claim 8, wherein each of the one or more event records comprises a key parameter, a value, a timestamp, and metadata.

10. The computer program product of claim 8, wherein the one or more event records are stored across one or more partitions of an event group within the distributed data register.

11. The computer program product of claim 10, wherein a first event record and a second event record of the one or more event records are stored in a first partition of the one or more partitions based on the first event record and the second event record sharing a common characteristic, wherein the common characteristic is a key parameter.

12. The computer program product of claim 10, wherein modifying the one or more optimization parameters comprises increasing a number of the one or more partitions within the distributed data register.

13. The computer program product of claim 8, wherein the latency metric comprises a latency target of less than 150 ms of end-to-end latency.

14. A computer-implemented method for processing network requests with ultra scale throughput and low latency in a networked computing environment, the computer-implemented method comprising:
detecting, in real time, one or more changes within a central data repository;
storing one or more event records within a distributed data register, wherein the one or more event records comprise the one or more changes within the central data repository;
receiving a network request from an external computing device;
modifying one or more optimization parameters associated with the network request based on one or more performance metrics, wherein the one or more performance metrics comprise a data availability metric, a latency metric, and a data throughput metric; and
serving the network request based on accessing the one or more event records within the distributed data register.

15. The computer-implemented method of claim 14, wherein each of the one or more event records comprises a key parameter, a value, a timestamp, and metadata.

16. The computer-implemented method of claim 14, wherein the one or more event records are stored across one or more partitions of an event group within the distributed data register.

17. The computer-implemented method of claim 16, wherein a first event record and a second event record of the one or more event records are stored in a first partition of the one or more partitions based on the first event record and the second event record sharing a common characteristic, wherein the common characteristic is a key parameter.

18. The computer-implemented method of claim 16, wherein modifying the one or more optimization parameters comprises increasing a number of the one or more partitions within the distributed data register.

19. The computer-implemented method of claim 14, wherein the latency metric comprises a latency target of less than 150 ms of end-to-end latency.

20. The computer-implemented method of claim 14, wherein the data throughput metric comprises a data throughput target of at least 100,000 transactions per second.
